(19) United States
(12) Patent Application Publication
(10) Pub. No.: US 2010/0126783 A1
(43) Pub. Date: May 27, 2010

(54) Electronic scale with automatic cable retraction device

(76) Inventor: Chiang Kao Chen, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/591,515

(22) Filed: Nov. 23, 2009

(30) Foreign Application Priority Data
Nov. 25, 2008 (TW) 097221094

(51) Int. Cl. G01G 21/28; G01G 23/00; H01R 13/72

(52) U.S. Cl. 177/239; 177/245; 439/501

(57) ABSTRACT

An electronic scale is provided with an automatic cable retraction device. The electronic scale includes a casing, a detection element, and the automatic cable retraction device. The casing forms an opening. The detection element is set in the casing for detecting a weight of an object-to-be-weighed and supplies the weight data. The automatic cable retraction device is received in the casing and contains therein an electric cable, which is withdrawable out of the casing and/or automatically retractable back into the casing. An end of the cable is connected to the detection element and an opposite end is coupled to an electric connector or a measurement controller, or a recording device. The electric connector or the measurement controller or the recording device can be retracted with the cable back into the casing through the opening. As such, an electronic scale with automatic cable retraction device is provided.

### BACKGROUND OF THE INVENTION

1. Field of the Invention

The present invention relates to an electronic scale with automatic cable retraction, and in particular to an electronic scale that features automatic cable retraction and is applicable to weighing of an object.

2. The Related Arts

An electronic scale has been commonly used to weigh various object, such as commodity that is sold in a market, or serving as a weighing device for industry commodity. The conventional electronic scales are undergoing digitalization and the measurement of the electronic scale is stored in digital forms for subsequent displaying, storage, and output for further applications. However, an electronic scale, to be operable, must be connected to an electrical cable to supply the measurement obtained with the electronic scale. The electric cable requires repeated mounting and dismounting and such an electric cable is often not allowed to be retracted or extendible. This makes the application and carrying of the electronic scale difficult and troublesome.

Further, the conventional electronic scale needs a digital operation panel for carrying out weighing operation, controlling and detecting data to be stored for subsequent application. The digital panel, however, is expensive and is not easy to repair once damaged. Thus, some of the conventional electronic scale uses an electrical cable to connect to a controller in order to omit the digital operation panel arranged on the scale itself. Again, the operation of such a panel-free electronic scale requires carrying the cable and the controller and repeated mounting/dismounting of the cable. This makes the use of the electronic scale very troublesome and is thus adverse to the development of the electronic scale industry.

Known references, such as Taiwan Utility Model Publication No. 543895, disclosed an adaptor for an electronic scale, wherein a transmission port is provided to the electronic scale for connection with an electric cable to a receiving port to output weight measurements of objects-to-be-weighed. The operation of this known scale needs additionally carrying the electric cable and accessories, such as electric connectors. Again, it is troublesome to use the electronic scale due to repeated mounting/dismounting of the cable and also due to that the cable cannot be retracted or selectively extended. The known scale suffers inconvenience of operation and carrying.

Taiwan Utility Model Publication No. 323610 disclosed an electronic scale for use in a refrigerant handling machine, wherein the electronic scale is combined with a refrigerant handling machine to measure weigh of refrigerant. Again, an additional cable or controller is needed for output of digital signals from the electronic scale. The same problem of inconvenience of repeated mounting/dismounting the cable and controller and carrying and storage occurs.

### SUMMARY OF THE INVENTION

The state-of-the-art electronic scale relies on an additional electric cable and controller in performing weighing operation, whereby inconvenience of repeated mounting/dismounting of the cable and controller and lacking of the function of retracting/extending of the cable, which lead to troubles in carrying and storage, are problems of the conventional electronic scales.

To overcome the problems and drawbacks of the conventional devices, the present invention provides an electronic scale featuring automatic cable retraction, wherein the electronic scale comprises a casing, a detection element, and an automatic cable retraction device. The casing forms an opening. The detection element is set in the casing for detecting a weight of an object-to-be-weighed and supplies the weight data. The automatic cable retraction device is received in the casing and contains therein an electric cable, which is selectively withdrawable out of the casing and/or automatically retractable back into the casing. An end of the cable is connected to the detection element and an opposite end is coupled to an electric connector or a measurement controller, or a recording device. The electric connector or the measurement controller or the recording device can be retracted with the cable back into the casing through the opening. As such, an electronic scale with automatic cable retraction device is provided.

The effectiveness of the electronic scale of the present invention is that an automatic cable retraction device is provided inside a casing of the electronic scale to allow an electric cable, together with an electric connector and a controller connected thereto, to be selectively withdrawable out of the electronic scale and automatically retractable back into the casing to eliminate the need of repeatedly mounting/dismounting the electric cable and/or the controller and to ensure easiness of carrying and convenience of use by the automatic retraction and/or selective withdrawability of cable in the electronic scale. Thus, operation of the electronic scale and industrial value are both enhanced.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view showing an electronic scale constructed in accordance with a first embodiment of the present invention;

FIG. 2 is an exploded view of the electronic scale of the first embodiment of the present invention;

FIG. 3 is a perspective view illustrating a casing member, together with a detection element and an automatic cable retraction device arranged therein, of the electronic scale of the first embodiment of the present invention;

FIG. 4 is a perspective view showing an electronic scale constructed in accordance with a second embodiment of the present invention;

FIG. 5 is an exploded view of the electronic scale of the second embodiment of the present invention shown in FIG. 4;

FIG. 6 is a perspective view illustrating a casing member, together with a detection element and an automatic cable retraction device arranged therein, of the electronic scale of the second embodiment of the present invention shown in FIG. 4;

FIG. 7 is a side elevational view of the electronic scale of the second embodiment of the present invention shown in FIG. 4;

FIG. 8 is an exploded view of the automatic cable retraction device in accordance with an example embodiment of the present invention;

FIG. 9 is a more detailed exploded view of the automatic cable retraction device of the example embodiment of the present invention;

FIG. 10 is an exploded view of the automatic cable retraction device in accordance with another example embodiment of the present invention;

FIG. 11 is a more detailed exploded view of the automatic cable retraction device of said another example embodiment of the present invention;

FIG. 12 is an exploded view of the automatic cable retraction device in accordance with a further example embodiment of the present invention; and

FIG. 13 is a more detailed exploded view of the automatic cable retraction device of said further example embodiment of the present invention.

### DETAILED DESCRIPTION OF THE PREFERRED EMBODIMENTS

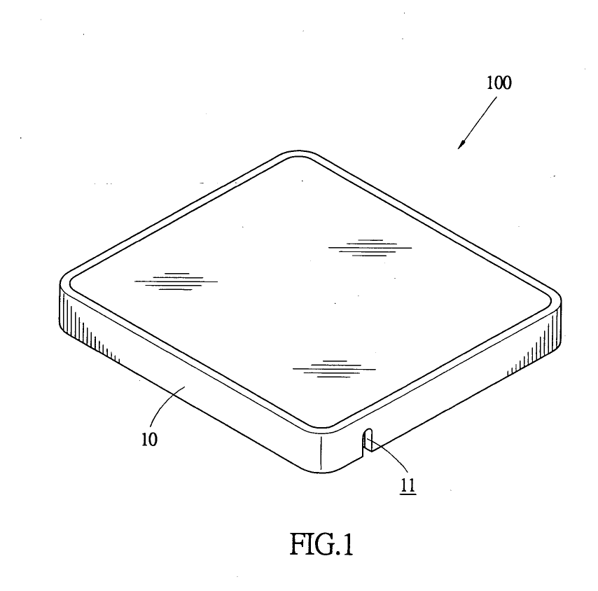

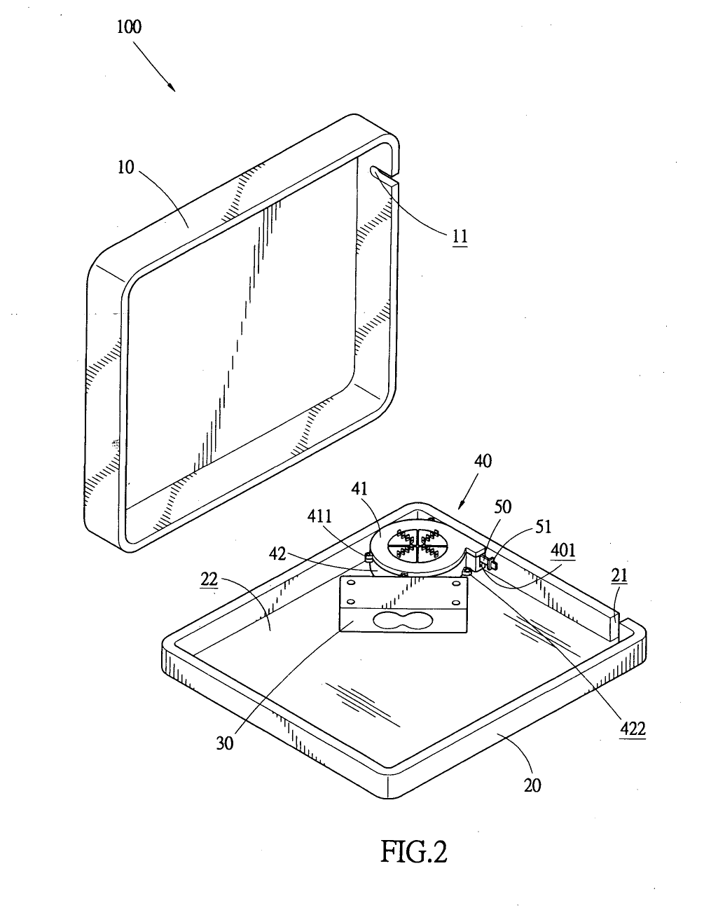

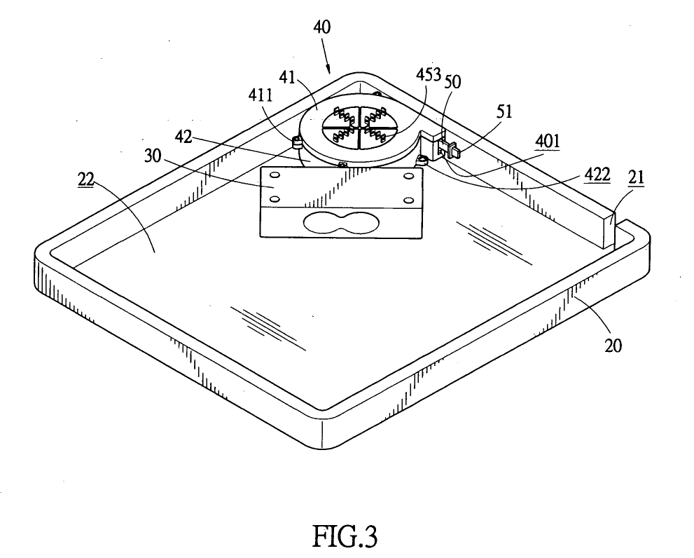

With reference to the drawings and in particular to FIGS. 1-3, which show an electronic scale constructed in accordance with a first embodiment of the present invention, generally designated with reference numeral 100, the electronic scale 100 of the present invention comprises two casing members 10, 20. The first casing member 10 has a circumferential flange forming at least one notch 11. The second casing member 20 has a circumferential flange forming a notch 21. The first casing member 10 is stacked on and mates the second casing member 20 in such a way that a receiving chamber 22 is defined in the second casing member 20 and the notches 21, 11 communicate each other to define an access opening.

A detection element 30 is set in the receiving chamber 22 of the casing member 20 to provide a function of weighing an object-to-be-weighed positioned on the casing member 10. The detection element 30 converts the weight of the object-to-be-weighed into an electric output signal.

At least one automatic cable retraction device 40 is set in the receiving chamber 22 of the casing members 20. The automatic cable retraction device 40 has at least one entry opening 401 and receives therein a length of electric cable 50. The cable 50 has an end connected to the detection element 30 and an opposite end connected to an electric connector 51, whereby the electric signal representing a weighing result of the object-to-be-weighed obtained by the detection element 30 is transmittable through the cable 50 and the electric connector 51 for output. The electric connector 51 of the cable 50 is withdrawable through the entry opening 401 of the automatic cable retraction device 40 and further through the notch 11 of the casing member 10 and the notch 21 of the casing member 20 for use. After the use, the cable 50 is released and is allowed to freely driven backward by a resilient force induced by the automatic cable retraction device 40 to have the cable 50 and the electric connector 51, as well as any external devices/members (not shown) coupled to the electric connector 51, retracted back into the receiving chamber 22 of the casing member 20 for storage.

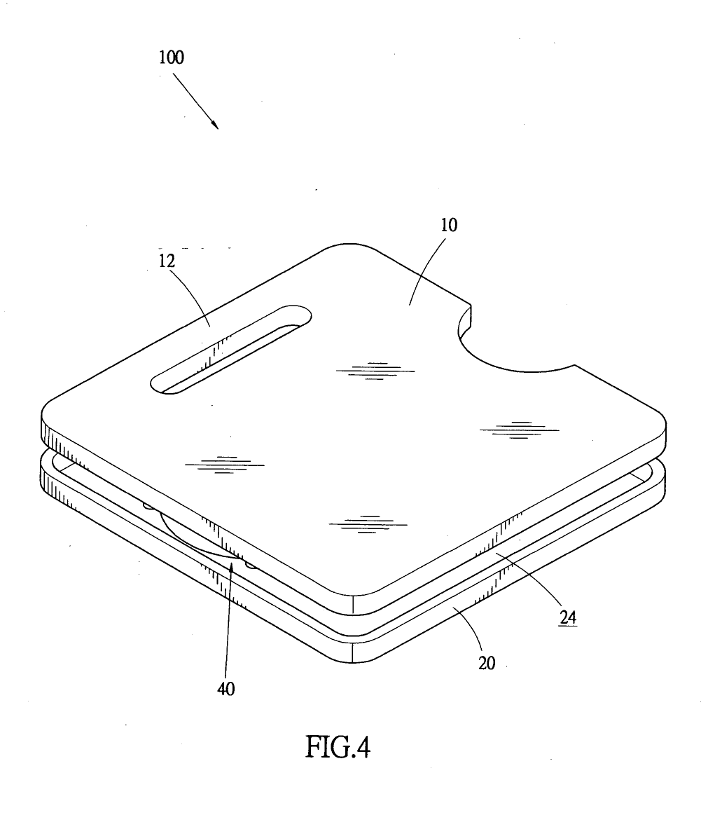

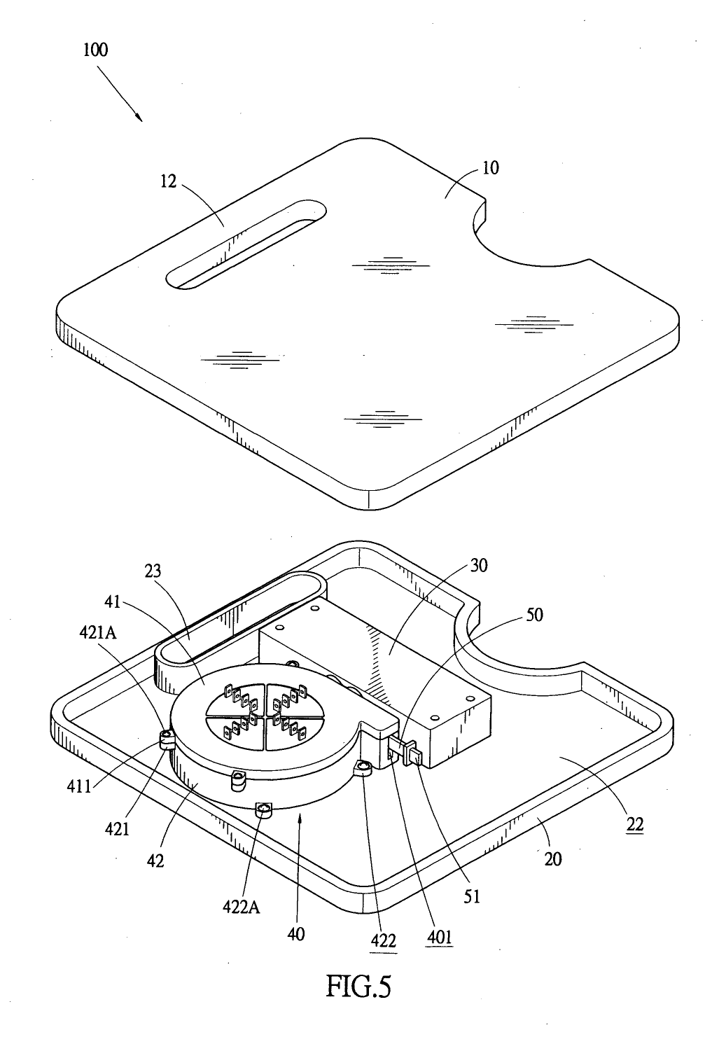

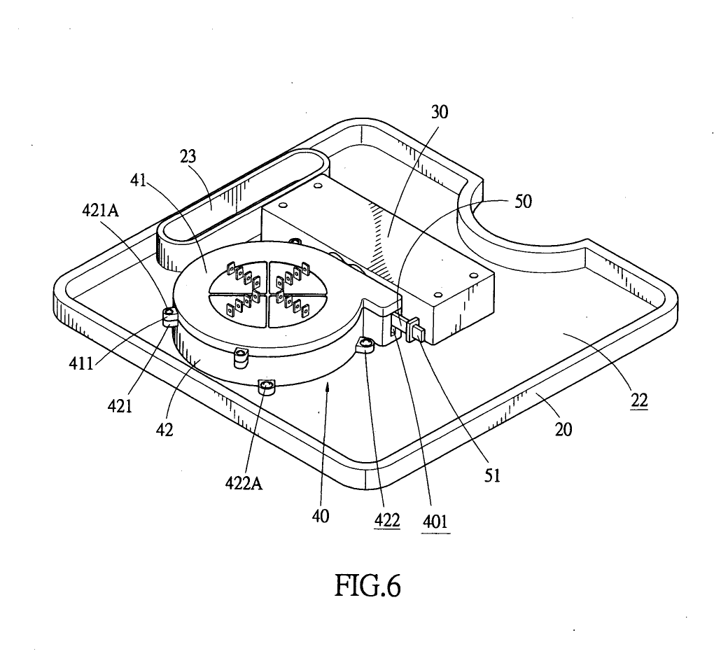

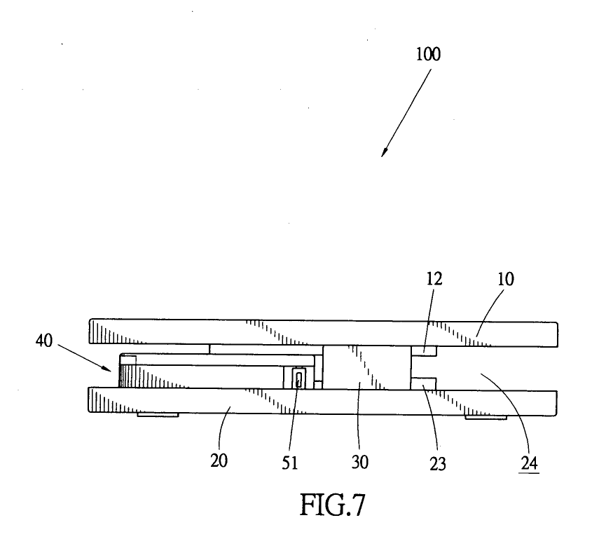

Referring to FIGS. 4-7, an electronic scale 100 constructed in accordance with a second embodiment of the present invention is illustrated, wherein a handle portion 12 is formed on the casing member 10 and a counterpart handle portion 23 is formed on the casing member 20. The detection element 30 and the automatic cable retraction device 40 are set between the casing member 10 and the casing member 20 (as shown in FIG. 7). An opening 24 is formed between the casing members 10, 20, whereby the cable 50 of the automatic cable retraction device 40 is allowed to be pulled outward from or retracted back into the automatic cable retraction device 40 through the opening 24 formed between the casing members 10, 20. The handle portions 12, 23 allow a user to hand hold the electronic scale 100 for carrying.

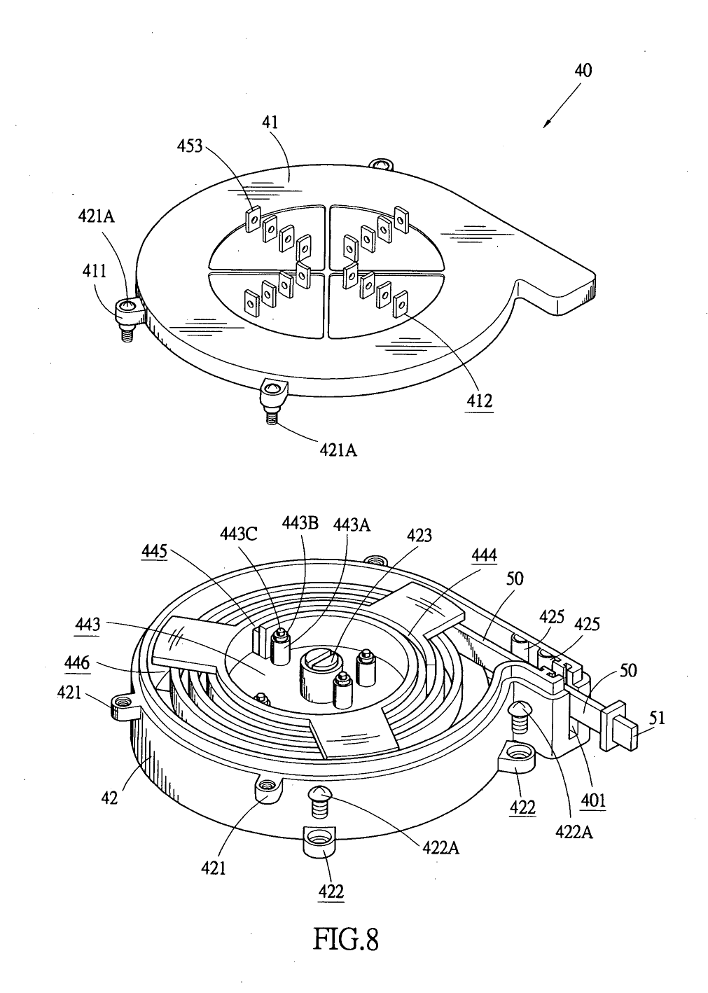

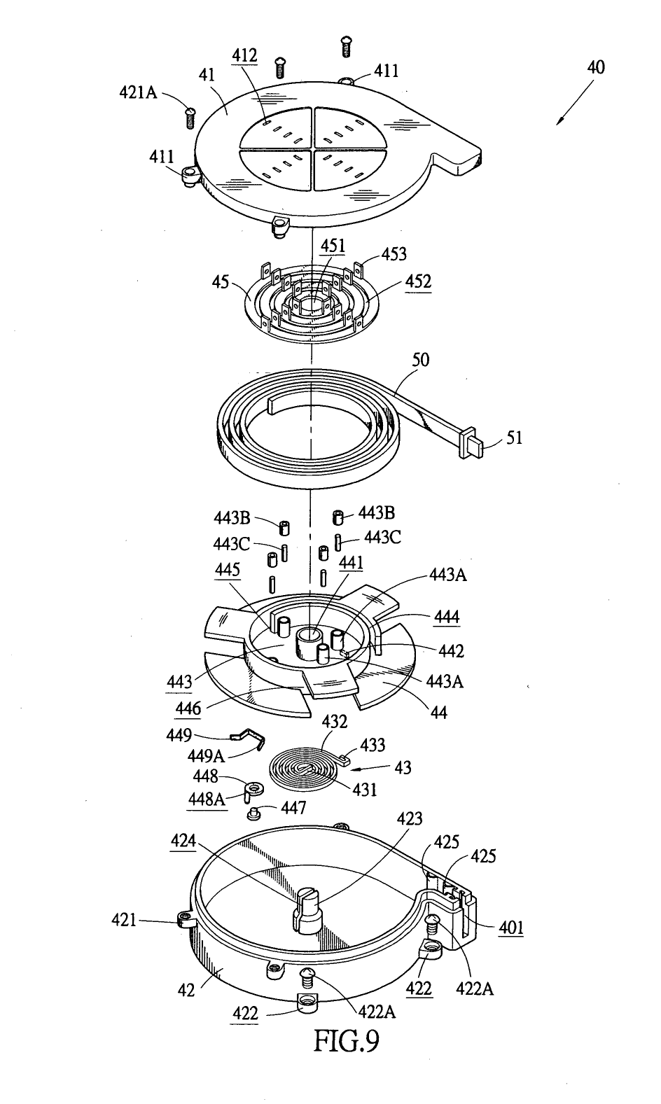

Referring to FIGS. 8 and 9, an example embodiment of the automatic cable retraction device 40 of the electronic scale 100 in accordance with the present invention is shown. The automatic cable retraction device 40 comprises a top cover 41, a bottom base 42, a coil spring 43, a rotary disk 44, a trace definition disk 45, and the cable 50. The top cover 41 has a circumference along which a plurality of fastening lugs 411 is formed. The top cover 41 also defines a plurality of through slots 412 on a surface thereof. The bottom base 42 has a circumference along which a plurality of fastening lugs 421 and mounting holes 422 are formed. The fastening lugs 421 are set to respectively correspond to the fastening lugs 411 of the top cover 41 and are secured together with bolts 421A so as to fix the top cover 41 and the bottom base 42 together. The mounting holes 422 receive bolts 422A extending therethrough and engaging a bottom of the casing member 20 of the electronic scale 100 to securely fix the bottom base 42 to the casing member 20. The bottom base 42 forms an axle 423 therein. A slit 424 is defined through the axle 423 and extends in an axial direction of the axle 423. The bottom base 42 has a circumferential flange defining the entry opening 401 of which an inside wall forms a plurality of guide boards 425.

The coil spring 43 has an inner end 431 fit into and retained by the slit 424 of the bottom base 42 and an outer end 432 forming a hook 433.

The rotary disk 44 forms a central bore 441 rotatably fit over the axle 423 of the bottom base 42, whereby the rotary disk 44 is rotatable about the axle 423. The rotary disk 44 forms a cavity 443 having a bottom on which a peg 442 is formed for engaging and thus fixing the hook 433 of the coil spring 43 thereon, whereby a biasing force is applied to the rotary disk 44 by the coil spring 43. A plurality of pin seats 443 is formed in the cavity 443, each receiving and holding a sleeve 443B that in turn receives and holds a pin 443C.

The cavity 443 of the rotary disk 44 also forms at least one cable slot 444 and a retention slot 445. A cable channel 446 is formed around an outer circumference of the rotary disk 44 and in communication with the cable slot 444. An end of the cable 50 is fixed in the retention slot 445 and an opposite extends through the cable slot 444 and further extends into and wind around the cable channel 446 to have the electric connector 51 mounted to said opposite end of the cable 50 completely received in the cable channel 446 for storage.

The bottom of the rotary disk 44 is coupled to a rotational shaft 447 that carries a brake roller 448. The brake roller 448 forms a retention groove 448A that fixes an end of a spring plate 449. The spring plate 449 has an opposite end that is put in contact engagement with an outer circumference of the rotary disk 44, whereby the brake roller 448 and the spring plate 449 may serve as a resilient ratchet mechanism to effect depression engagement and positioning against the coil spring 43 and the rotary disk 44 at the time when the rotary disk 44 is driven to rotate by the spring force of the coil spring 43, so that the coil spring 43 may maintain positioning and stably release the spring force in order to ensure stable positioning and rotational operation of the rotary disk 44.

The trace definition disk 45 forms a central bore 451 that is fit over a top end of the axle 423 of the bottom base 42. The trace definition disk 45 forms a plurality of tracks 452 and a plurality of ribs 453. The tracks 452 are in the form of elongate through slots that slidably receives the pins 443C therein for stably guiding the rotational motion of the rotary disk 44. The ribs 453 are fit into the slots 412 of the top cover 41 to ensure secure coupling between the trace definition disk 45 and the top cover 41, whereby the trace definition disk 45 may provide support for stable rotation of the rotary disk 44.

In practical operation of the automatic cable retraction device 40, the end of the cable 50 to which the electric connector 51 is mounted can be withdrawn by being pulled outward through the entry opening 401 and the guide boards 425 guide the withdrawal of the cable 50. At this time, the rotary disk 44 undergoes clockwise rotation and the coil spring 43 is driven thereby to simultaneously do clockwise rotation and is tightly wound up to induce a compression spring force. The brake roller 448 and the spring plate 449 arranged on the bottom of the rotary disk 44 provide guiding and positioning to the compression of spring. After the use of the cable 50, the cable 50 is further pulled outward and then released and by doing so, the brake roller 448 and the spring plate 449 spontaneously loss the function of positioning, and the coil spring 43 is allowed to release the compression spring potential, causing counterclockwise rotation of the rotary disk 44 and retracting the cable 50 back into the cable channel 446 formed around the rotary disk 44. With this, automatic retraction of the cable 50 and the electric connector 51 back into the receiving chamber 22 of the casing member 20 is realized.

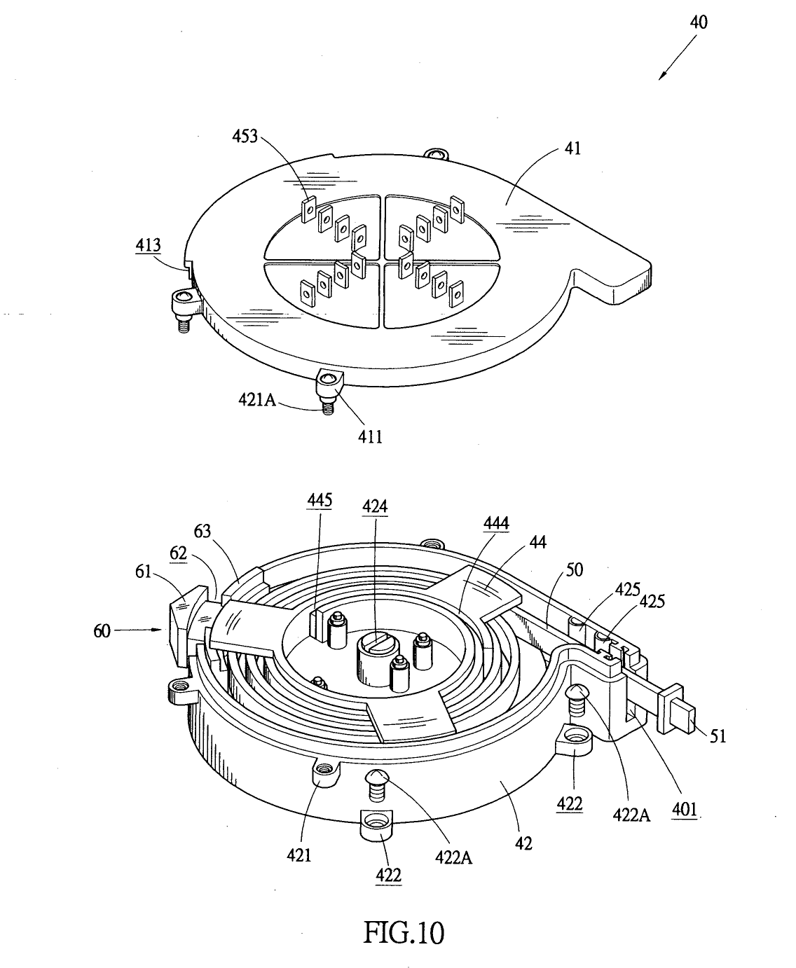

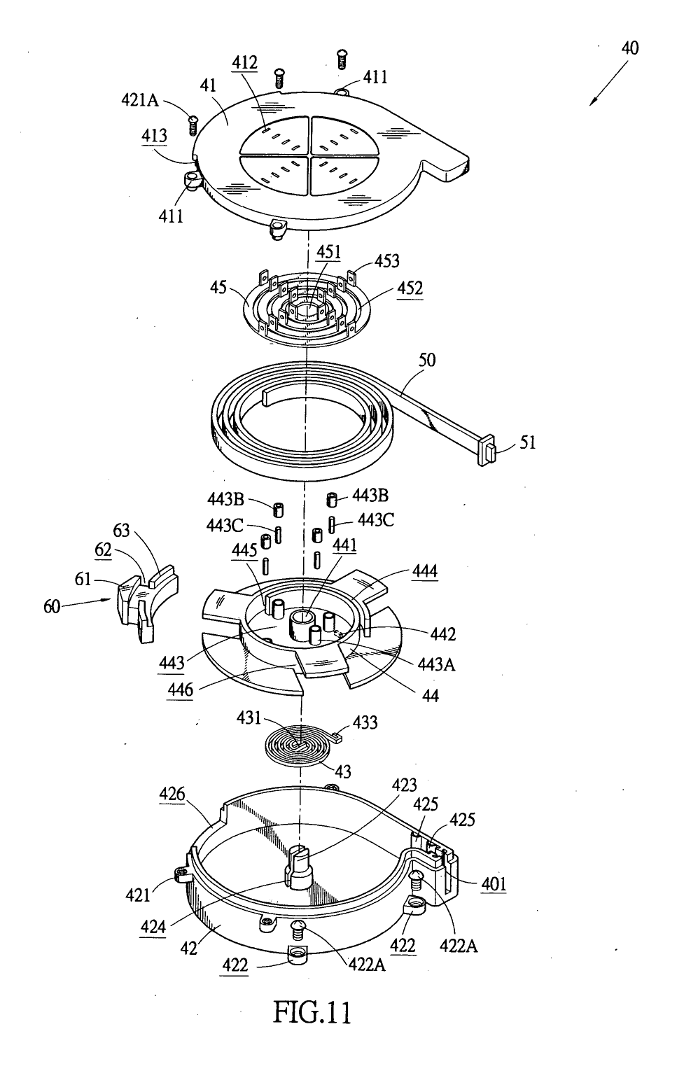

Referring to FIGS. 10 and 11, another example embodiment of the automatic cable retraction device 40 of the electronic scale 100 in accordance with the present invention is illustrated. In this instant example, the rotational shaft 447, the brake roller 448, and the spring plate 449 are omitted from the bottom of the rotary disk 44, and instead, the top cover 41 forms a slot 413 in an outer circumference and the bottom base 42 also forms a slot 426 in an outer circumference thereof. A resilient retention knob 60 has an end forming an operation section 61 and an opposite end forming a fitting section 62 and a brake board 63. The fitting section 62 is fit in the slot 426 of the bottom base 42 and the operation section 61 is located between the slot 413 of the top cover 41 and the slot 426 of the bottom base 42. The operation section 61 is movable back and forth to selectively change the location of the fitting section 62 between the slot 426 and an outer wall of the bottom base 42, so as to change resiliently deformed length of the brake board 63, by which the brake board 63 may selectively abut against an outer circumference of the cable 50 wound around the cable channel 446 of the rotary disk 44 to effect positioning of the cable 50 for the withdrawal thereof, or selectively separate from the cable 50 to allow the cable 50 to be freely pulled outward or aquatically and resiliently retracted. The resilient retention knob 60 can be set on the embodiment of the electronic scale 100 shown in FIGS. 4-7, namely serving as the automatic cable retraction device 40 for the open type casing members 10, 20 to allow a user to operate the operation section 61 of the resilient retention knob 60 through the opening 24 between the casing members 10, 20.

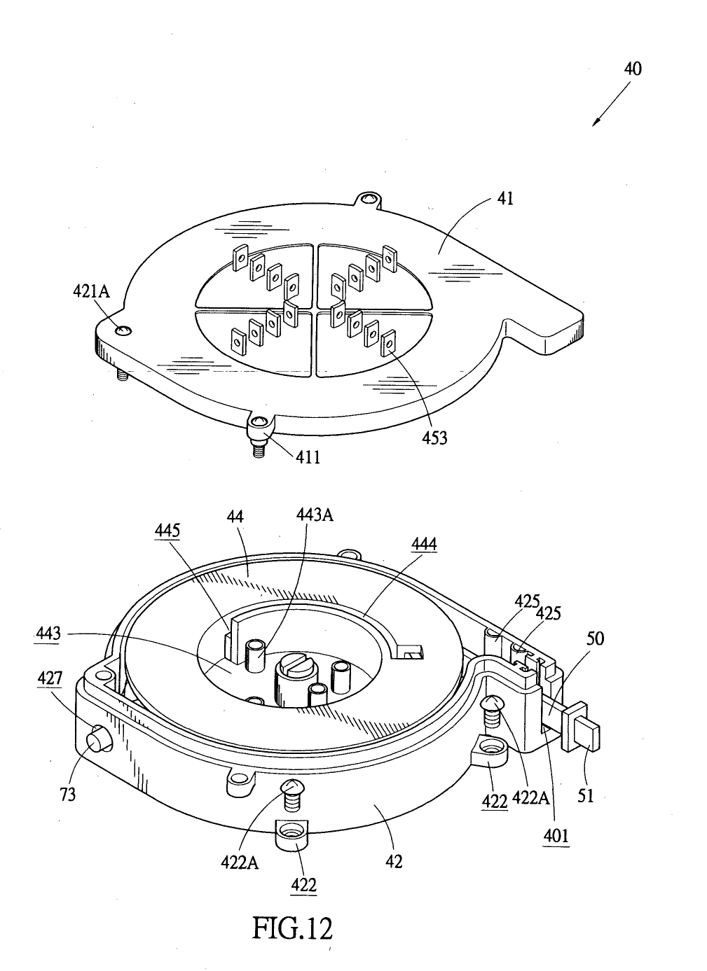

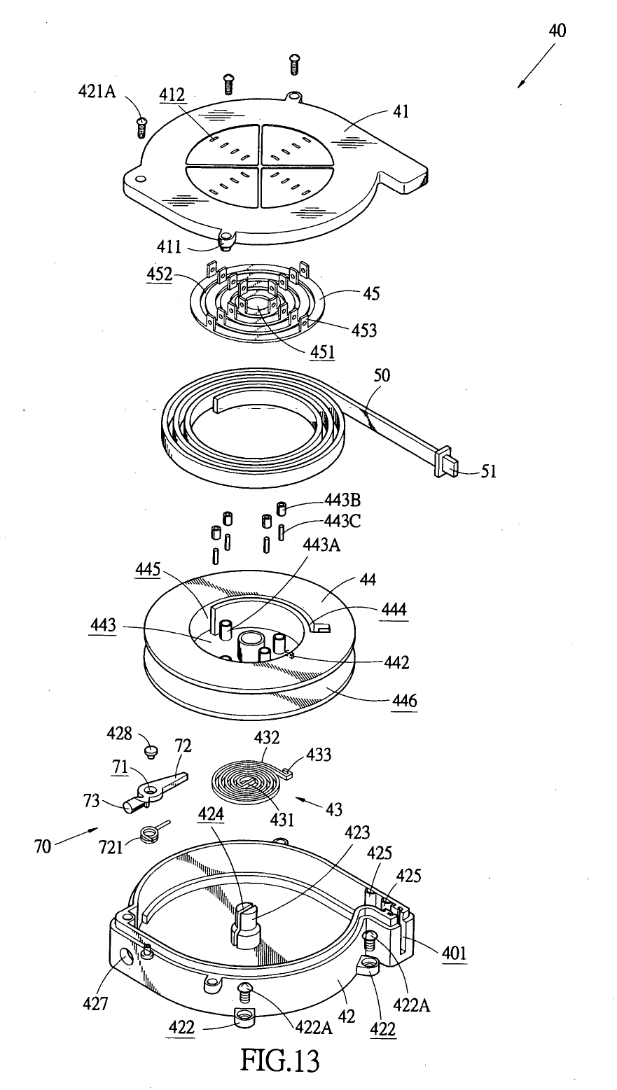

Referring to FIGS. 12 and 13, a further example embodiment of the automatic cable retraction device 40 of the electronic scale 100 in accordance with the present invention is illustrated. In this instant example, the rotational shaft 447, the brake roller 448, and the spring plate 449 are omitted from the bottom of the rotary disk 44, and instead, the bottom base 42 forms a through hole 427 in an outer circumferential wall thereof. A shaft 428 is set in the interior of the bottom base 42. A resilient brake board 70 forms a hole 71 fit over the shaft 428 in a rotatable manner. The resilient brake board 70 forms, at an end thereof, a brake section 72 and a resilient element 721 is arranged between the brake section 72 and the shaft 428 to bias the brake section 72 against an outer circumference of the cable 50 wound around the cable channel 446 of the rotary disk 44 for positioning the cable 50 during withdrawal of the cable 50. The resilient brake board 70 forms a depression section 73 on an opposite end. The depression section 73 extends through the hole 427 of the bottom base 42 to be accessible by a user for inward depression of the depression section 73, by which the brake section 72 is rotated outward to disengage from the outer circumference of the cable 50 that is wound around the cable channel 446 of the rotary disk 44, allowing the cable 50 to be freely pulled outward for withdrawal or automatically retracted backward in order to realize the function of automatic retraction of the cable 50 and the electric connector 51. At this time, the resilient element 721 is in a compressed condition. Once the depression section 73 is released, the resilient potential of the resilient element 721 is released to rotate the brake section 72 back into abutting engagement with the outer circumference of the cable 50 to thereby maintain a braking condition; and the depression section 73 is returned to the user accessible condition for subsequent operation.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An electronic scale, comprising:
a casing member, which has a circumferential flange forming at least one notch and defines an internal receiving space;
a detection element, which is set in the receiving space and adapted to detect weight of an object-to-be-weighed, the detection element converting the detected weight into a corresponding electric output signal;
at least one automatic cable retraction device, which is arranged in the receiving space of the casing member and has at least one entry opening, the automatic cable retraction device receiving an electric cable therein, the cable having a first end connected to the detection element and a second end for supplying the electric output signal for output, the second end of the cable being extendible outward through the entry opening of the automatic cable retraction device and further extendible outward through the notch of the casing member for operation, wherein after use and the cable is released, the automatic cable retraction device automatically retracts the cable back into the receiving space of the casing member.

2. The electronic scale as claimed in claim 1, wherein the second end of the cable is coupled with an electric connector.

3. The electronic scale as claimed in claim 1, wherein the automatic cable retraction device comprises:
a top cover, which has a circumference along which a plurality of first fastening lugs is formed and has a surface in which a plurality of through slots is defined;
a bottom base, which has a circumference along which a plurality of second fastening lugs is formed, the second fastening lugs corresponding to and coupled to the first fastening lugs of the top cover, the bottom base being fixed to a bottom of the casing member;
a coiling spring, which has an inner end fixed to the bottom base and an outer end forming a hook;
a rotary disk, which forms a central bore rotatably fit over an axle formed on the bottom base to allow the rotary disk to be rotatable about the axle, the rotary disk forming a peg for fixing the hook of the coil spring so as to apply a biasing force to the rotary disk by the coil spring, the rotary disk forming a cavity in which a plurality of pins is arranged, the cavity of the rotary disk forming at least one cable slot and a retention slot, a cable channel being formed around an outer circumference of the rotary disk and in communication with the cable slot, the first end of the cable being retained in the retention slot and an opposite extending through the cable slot and further extending into and wound around the cable channel to have the second end of the cable completely received in the cable channel for storage; and
a trace definition disk, which forms a central bore fit over a top end of the axle of the bottom base, the trace definition disk forming a plurality of tracks and a plurality of ribs, the tracks slidably receiving the pins therein for stably guiding rotational motion of the rotary disk, the ribs being fit into the slots of the top cover to secure the trace definition disk to the top cove.

4. The electronic scale as claimed in claim 1, wherein a resilient retention knob is arranged between the top cover and the bottom base.

5. The electronic scale as claimed in claim 4, wherein the resilient retention knob comprises an operation section, a fitting section, and a brake board.

6. The electronic scale as claimed in 1, wherein a resilient brake board is arranged between the top cover and the bottom base.

7. The electronic scale as claimed in 6, wherein the resilient brake board comprises a brake section, a resilient element, and a depression section.
